(19) United States
(12) Patent Application Publication
(10) Pub. No.: US 2026/0031743 A1
(43) Pub. Date: Jan. 29, 2026

(54) POWER SUPPLYING DEVICE AND CONTROLLING METHOD THEREOF

(71) Applicant: DELTA ELECTRONICS, INC., Taoyuan City (TW)

(72) Inventors: Chin-Te KU, Taoyuan City (TW); Deng-Cyun HUANG, Taoyuan City (TW); Wei-Hsin WEN, Taoyuan City (TW); Yi-Hsun CHIU, Taoyuan City (TW); Chia-Hsiong HUANG, Taoyuan City (TW)

(21) Appl. No.: 19/096,763

(22) Filed: Apr. 1, 2025

Related U.S. Application Data
(60) Provisional application No. 63/676,447, filed on Jul. 29, 2024.

(30) Foreign Application Priority Data
Jan. 23, 2025 (CN) 202510110219.5

(51) Int. Cl. H02M 7/219

(52) U.S. Cl. CPC H02M 7/219

(57) ABSTRACT

A power supplying device comprises a converter circuit, configured to provide power to a load according to input power sources. The converter circuit comprises: input terminals coupled to the input power sources; a first and second output terminals coupled to the load, generating an output voltage according to the input sources; a first capacitor coupled to the first output terminal and a first midpoint; a second capacitor coupled to the second output terminal and the first midpoint; filtering capacitors coupled to the input sources and a second midpoint; a switch coupled to the first and second midpoints; and a controller controlling the switch according to an input voltage of the input terminals; wherein when the input voltage is lower than a predetermined voltage level, the switch is conducted, and when the input voltage is higher than the predetermined voltage level, the switch is not conducted.

### CROSS-REFERENCE TO RELATED APPLICATION

This application claims priority to and the benefit of China Patent Application Number 202510110219.5, filed on Jan. 23, 2025, and claims priority to and the benefit of U.S. Provisional Application No. 63/676,447, filed on Jul. 29, 2024, entitled “Switch on Neutral Path for Three Phase Three Wire Three Level Converter”, which are incorporated herein by reference in their entirety for all purposes.

### BACKGROUND

### Technical Field

The present disclosure relates to a power supplying device. More particularly, the present disclosure relates to a power supplying device having a midpoint path switch and a power factor correction, and controlling method thereof.

### Description of Related Art

To reduce the electromagnetic interference generated by a high frequency current, the Three Phase Three Wire Three Level Converter is designed to reduce the generation of the common-mode noise. The design is implemented by connecting a midpoint between output capacitors to a neutral point composed with capacitors. However, the design of the converter mentioned above generates higher voltage in the output terminal. Therefore, when the input voltage increases, the output capacitors require higher spec of voltage to withstand the increased voltage.

### SUMMARY

The present disclosure provides a power supplying device. The power supplying device is configured to provide power to a load according to a plurality of input power sources. The power supplying device comprises a converter circuit. The converter circuit comprises a plurality of input terminals configured to be coupled to one of the plurality of input power sources, respectively; a first output terminal and a second output terminal, configured to be coupled to the load, and configured to generate an output voltage to supply power to the load according to the plurality of input power sources; a first capacitor coupled to the first output terminal and a first midpoint; a second capacitor coupled to the second output terminal and the first midpoint; a first filtering capacitor, a second filtering capacitor, and a third filtering capacitor, respectively coupled to one of the plurality of input power sources and coupled to a second midpoint; a switch coupled to the first midpoint and the second midpoint; and a controller configured to control the switch according to an input voltage of the plurality of input terminals; wherein when the input voltage of the plurality of input terminals is lower than a predetermined voltage level, the switch is configured to be conducted, and when the input voltage of the plurality of input terminals is higher than the predetermined voltage level, the switch is configured to be not conducted.

The present disclosure provides a power supplying device. The power supplying device comprises a plurality of input power sources coupled to a first midpoint; a plurality of input terminal coupled to the plurality of input power sources; a converter circuit coupled to the plurality of input power sources; a switch coupled to each of the first midpoint and a second midpoint; and a controller configured to control the switch according to an input voltage, wherein the first midpoint is coupled to each of a first output terminal and a second output terminal, when the input voltage of the plurality of input terminals is higher than a predetermined voltage level, the controller sets the switch to be conducted, and when the input voltage of the plurality of input terminals is lower than a predetermined voltage level, the controller sets the switch to be not conducted.

The present disclosure provides a method for controlling a power supply device coupled to a plurality of input power sources for providing power to a load wherein the power supplying device comprises: a converter circuit, comprising: a plurality of input terminals coupled to one of the plurality of input power sources, respectively; a first output terminal and a second output terminal coupled to the load for generating an output voltage to supply power to the load according to the plurality of input power sources; a first capacitor coupled to the first output terminal and a first midpoint; a second capacitor coupled to the second output terminal and the first midpoint; a first filtering capacitor, a second filtering capacitor, and a third filtering capacitor, respectively coupled to one of the plurality of input power sources and coupled to a second midpoint; and a switch coupled to the first midpoint and the second midpoint. The method comprises receiving the input voltage from the input power sources by the input terminals of the converter circuit; performing a power converting operation of the input voltage by the converter circuit to generate the output voltage; generating the output voltage at the first midpoint between the first capacitor and the second capacitor of the converter circuit; when the input voltage of the plurality of input terminals is lower than a predetermined voltage level, configuring the switch to be conducted, and when the input voltage of the plurality of input terminals is higher than the predetermined voltage level, configuring the switch to be not conducted.

It is to be understood that both the foregoing general description and the following detailed description are by examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a power supplying device, illustrated in accordance with some embodiments of the present disclosure.

FIG. 2 is a schematic diagram of a power supplying device, illustrated in accordance with some embodiments of the present disclosure.

### DETAILED DESCRIPTION

In the present disclosure, when an element is referred to as “connected” or “coupled”, it may mean “electrically connected” or “electrically coupled”. “Connected” or “coupled” can also be used to indicate that two or more components operate or interact with each other. In addition, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present invention belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

Hereinafter multiple embodiments of the present disclosure will be disclosed with schema, as clearly stated, the details in many practices it will be explained in the following description. It should be appreciated, however, that the details in these practices is not applied to limit the present disclosure. Also, it is to say, in some embodiments of the present disclosure, the details in these practices are non-essential. In addition, for the sake of simplifying schema, some known usual structures and element in the drawings by a manner of simply illustrating for it.

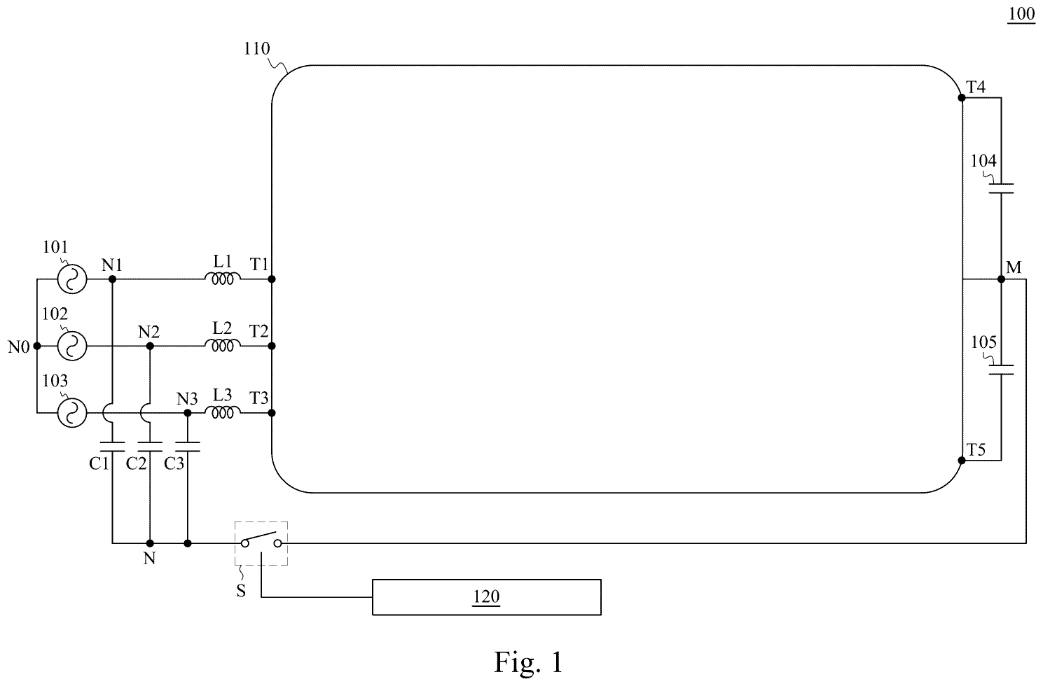

FIG. 1 is a schematic diagram of a power supplying device 100, illustrated in accordance with some embodiments of the present disclosure. As illustratively shown in FIG. 1, the power supplying device 100 includes a converter circuit 110, a controller 120, input power sources 101-103, inductors L1-L3, filtering capacitors C1-C3, capacitors 104-105, and a switch S.

As illustratively shown in FIG. 1, a terminal of the input power source 101 is coupled to a node NO, and another terminal of the input power source 101 is coupled to a node N1. A terminal of the inductor L1 is coupled to the node N1, and another terminal of the inductor L1 is coupled an input terminal T1 of the converter circuit 110. A terminal of the input power source 102 is coupled to the node NO, and another terminal of the input power source 102 is coupled to a node N2. A terminal of the inductor L2 is coupled to the node N2, another terminal of the inductor L2 is coupled to an input terminal T2 of the converter circuit 110. A terminal of the input power source 103 is coupled to the node NO, and another terminal of the input power source 103 is coupled to a node N3. A terminal of the inductor L3 is coupled to the node N3, and another terminal of the inductor L3 is coupled to an input terminal T3 of the converter circuit 110.

In some embodiments, an output terminal T4 of the converter circuit 110 is coupled to a terminal of the capacitor 104, and another terminal of the capacitor 104 is electrically coupled to a midpoint M. An output terminal T5 of the converter circuit110 is coupled to a terminal of the capacitor 104, and another terminal of the capacitor 104 is electrically coupled to the midpoint M.

In some embodiments, a terminal of the filtering capacitor C1 is coupled to the node N1, and another terminal of the filtering capacitor C1 is coupled to a midpoint N. A terminal of the filtering capacitor C2 is coupled to the node N2, and another terminal of the capacitor C2 is coupled to the midpoint N. A terminal of the filtering capacitor C3 is coupled to the node N3, and another terminal of the capacitor C3 is coupled to the midpoint N. A terminal of the switch S is coupled to the midpoint N, and another terminal of the switch S is coupled to the midpoint M, and is configured to electrically couple the midpoint N to the midpoint M. The controller 120 is coupled to the switch S, and is configured to control the switch S.

In some embodiments, the input power sources 101-103 are configured to provide an input voltage VLL to the converter circuit 110 through the inductors L1-L3, respectively. The converter circuit 110 is configured to generate an output voltage Vbus at the midpoint M according to the input voltage VLL. In some embodiments, the controller 120 is configured to set the switch S to be conducted or not conducted according to a voltage level of the input voltage VLL.

In some embodiments, the converter circuit 110 has a configuration of a Three Phase Three Wire Three Level Converter, and the converter circuit 110 can be implemented by a Power Factor Correction (PFC) converter circuit, but the present disclosure is not limited to any configuration of the converter circuit. In some embodiments, the input power sources 101-103 can be implemented by an Alternating Current (AC) power supply.

In some embodiments, each of the inductor L1-L3 and the filtering capacitor C1-C3 can be implemented together as a LC oscillating circuit filter, and is configured to decrease an electromagnetic interference generated by each of the input power sources 101-103 to the converter circuit 110. Alternatively stated, each of the filtering capacitors C1-C3 is also called Electro Magnetic Interference (EMI) capacitors.

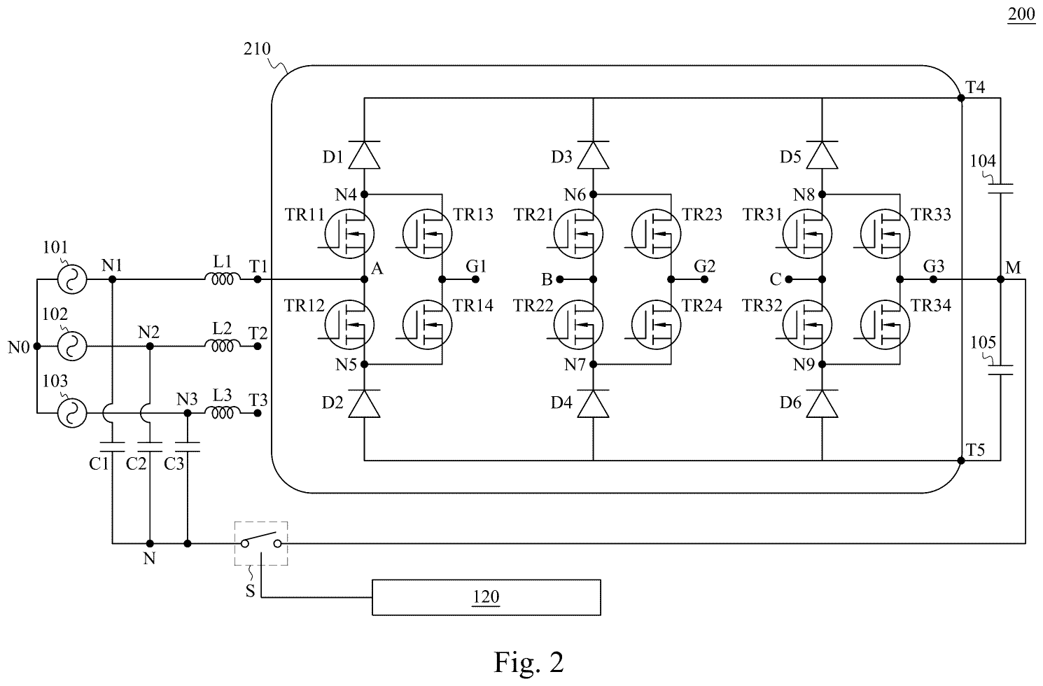

In some embodiments, the midpoint M is a middle point between the capacitors 104 and 105. In some embodiments, the midpoint N connecting each of the filtering capacitors C1-C3 is called virtually neutral point, and when the switch is conducted, the midpoint N has a voltage being same as the output voltage Vbus of the midpoint M. Further details regarding the operation of each of the midpoints N, M, and the switch S are discussed in FIG. 2 and corresponding paragraph of the present disclosure.

In some embodiments, when the midpoint N is disconnected with midpoint M, the output voltage Vbus has an output voltage level Voff, and the output voltage level Voff is equal to the voltage level of the input voltage VLL multiplied by \sqrt{2}. When the midpoint N is connected with midpoint M, the output voltage Vbus has an output voltage level Von, and the output voltage level Von is equal to the voltage level of the input voltage VLL multiplied by 2\sqrt{2} and divided by \sqrt{3}. In this way, the power supplying device 100 is able to adjust the voltage level of the output voltage Vbus to VLL×(2\sqrt{2})\sqrt{3} and VLL×\sqrt{2} by setting the switch S to be conducted or not conducted, respectively.

In some approach, to reduce the electromagnetic interference generated by high frequency input current provided by input power sources, the configuration of the Three phases Three level PFC converter circuit connects the midpoint of the output capacitors to a virtually neutral point composed by filtering capacitors, so as to reduce the generation of the common mode noise. However, in the above mentioned configuration, when a voltage level of the input voltage is higher, the converter circuit generates a higher voltage level of the output voltage at the output terminal. Therefore, the output capacitor requires higher spec of the rating voltage.

Compare to the above approach, in some embodiments of the present disclosure, to decrease the spec of the rating voltage of the output capacitors 104 and 105, the disclosed power supplying device 100 connects the midpoints N and M by the switch S, and controls the setting of the switch S, setting to be conducted or not conducted, by the controller 120 according to the voltage level of the input voltage VLL. When the voltage level of the input voltage is higher, the power supplying device 100 adjusts the output voltage Vbus to a lower output voltage level by controlling the switch S, such that a lowered spec of rating voltage of the capacitors 104 and 105 is achieved.

In various embodiments, the power supplying device 100 can be implemented by various type of Three Phase Three Level voltage converter circuit, such as the PFC converter circuit, but the present disclosure is not limited to this type of converter circuit.

In some operations, the power sources 101-103 are configured to provide the input voltage VLL to the converter circuit 110, respectively, by enabling the power supplying device 100.

Specifically, the power source 101 is configured to provide the input voltage VLL to the input terminal T1 of the converter circuit 110 through the inductor L1. The power source 102 is configured to provide the input voltage VLL to the input terminal T2 of the converter circuit 110 through the inductor L2. The power source 103 is configured to provide the input voltage VLL to the input terminal T3 of the converter circuit 110 through the inductor L3.

In some operations, the converter circuit 110 is configured to generate the output voltage Vout at each of the output terminals T4 and T5 according to the input voltage VLL. Wherein the output voltage Vout indicates a voltage between the output terminals T4 and T5.

In some embodiments, the output voltage Vout has a Direct Current (DC) form, but the present disclosure is not limited to this.

In some operations, each of the capacitors 104 and 105 is configured to generate the output voltage Vbus at the midpoint M according to the output voltage Vout.

Specifically, the output voltage Vout generated by each of the output terminals T4 and T5 generates the output voltage Vbus at the midpoint M through each of the capacitors 104 and 105. Wherein the midpoint is coupled between the capacitors 104 and 105.

In some operations, the power supplying device 100 calculates a predetermined voltage level Vth according to a rating voltage Vspec of each of the capacitors 104 and 105.

Specifically, the predetermined voltage level Vth of each of the capacitors 104 and 105 is calculated as follow. When the switch S, connecting the midpoints N and M is conducted, the predetermined voltage level Vth is equal to the rating voltage Vspec divided by \sqrt{3}, that is, Vth=(2×Vspec)/\sqrt{3}.

For example, when the rating voltage Vspec of each of the capacitors 104 and 105 has a voltage level of 450 volt, the predetermined voltage level Vth, corresponding to each of the capacitors 104 and 105, has a voltage level of approximately 551 volt.

For another example, when the rating voltage Vspec of each of the capacitors 104 and 105 has a voltage level of 500 volt, the predetermined voltage level Vth, corresponding to each of the capacitors 104 and 105, has a voltage level of approximately 612 volt. Alternatively stated, when the rating voltage Vspec is higher, the predetermined voltage level Vth is higher. When the rating voltage Vspec is lower, the predetermined voltage level Vth is lower.

In some embodiments, each of the capacitors 104 and 105 has rating voltages Vspec1 and Vspec2, respectively. The rating voltages Vspec1 and Vspec2 are configured to indicate the voltage level that each of the capacitors 104 and 105 can sustain. Wherein the rating voltages Vspec1 and Vspec2 are a reference voltage level which is configured to provide protection to each of the capacitors 104 and 105, and maintain normal functionality among other internal elements.

For example, when the voltage level of the output voltage Vout is higher than the voltage level of the rating voltage Vspec1 of the capacitor 104, the capacitor 104 suffers an overvoltage from the output voltage Vout and being damaged. When the voltage level of the output voltage Vout is higher than the voltage level of the rating voltage Vspec2 of the capacitor 105, the capacitor 105 suffers the overvoltage from the output voltage Vout and being damaged. In some embodiments, each of the capacitors 104 and 105 has the same rating voltage Vspec and the same capacitance. Alternatively stated, the voltage level of the rating voltage Vspec1 is equal to the voltage level of the rating voltage Vspec1.

In some operations, the power supplying device 100 determines whether the voltage level of the input voltage VLL is higher than the predetermined voltage level Vth.

In some circumstances, when the voltage level of the input voltage VLL is higher than the predetermined voltage level Vth, the power supplying device 100 sets the switch S to be not conducted, such that the midpoint N is disconnected with the midpoint M. For example, when the voltage level of the rating voltage Vspec of each of the capacitors 104 and 105 is 450 volt, the predetermined voltage level Vth has a voltage level of approximately 551 volt. When the voltage level of the input voltage VLL is 560 volt, the power supplying device 100 determines the voltage level of the input voltage VLL is higher than the predetermined voltage level Vth and the switch S is not conducted.

In these circumstances, when the switch S is not conducted, the voltage level Voff of the output voltage Vbus generated at the midpoint M has approximately 792 volt. At this moment, each of the capacitors 104 and 105, connected to the midpoint M, has a voltage level 396 volt, which is a voltage level 792 volt divided by 2. Wherein the voltage level 396 volt is lower than the voltage level 450 volt of the rating voltage Vspec.

In some other circumstances, when the voltage level of the input voltage VLL is lower than the predetermined voltage level Vth, the power supplying device 100 sets the switch S to be conducted, such that the midpoint N is connected to the midpoint M. For example, when the voltage level of the rating voltage Vspec of each of the capacitors 104 and 105 is 450 volt, the predetermined voltage level Vth has a voltage level of approximately 551 volt. When the voltage level of the input voltage VLL is 550 volt, the power supplying device 100 determines the voltage level of the input voltage VLL is lower than the predetermined voltage level Vth and the switch S is conducted. At this moment, the power supplying device 100 is operating normally.

In these circumstances, when the switch S remains conducted, the voltage level Von of the output voltage Vbus generated at the midpoint M has approximately 898 volt. At this moment, each of the capacitors 104 and 105, connected to the midpoint M, has a voltage level 449 volt, which is a voltage level 898 volt divided by 2. Wherein the voltage level 449 volt is lower than the voltage level 450 volt of the rating voltage Vspec.

In some embodiments, the power supplying device 100 is operating normally is referred as the operating status of the power supplying device 100 when the switch S is conducted and the midpoint is connected to the midpoint M. When the power supplying device 100 is operating normally, the output voltage Vbus has the voltage level Von, and the voltage level Von is equal to the voltage level of the input voltage VLL multiplied by \sqrt{3}.

In some embodiments, the disclosed power supplying device 100 can control the switch S to be conducted and not conducted according to the voltage level of the input voltage VLL. When the voltage level of the input voltage VLL is higher, the power supplying device 100 can adjust the voltage level of the output voltage Vbus by controlling the switch S, such that the voltage level of each of the capacitors 104 and 105 is lower than the voltage level of the rating voltage Vspec, achieving the use of each of the capacitors 104 and 105 having a lower spec of rating voltage Vspec. When the voltage level of each of the capacitors 104 and 105 is lower than the voltage level of the rating voltage Vspec, the power supplying device 100 can maintain normal functionality among internal elements and decrease the power consumption by using a capacitor having a lower spec of rating voltage.

FIG. 2 is a schematic diagram of the power supplying device 200, illustrated in accordance with some embodiments of the present disclosure. FIG. 2 illustrates an embodiment of the converter circuit 110 in FIG. 1. As illustratively shown in FIG. 2, the power supplying device 200 includes the internal devices and elements of the power supplying device 100.

As illustratively shown in FIG. 2, the converter circuit 210 of the power supplying device 200 further includes multiple diodes D1-D6, multiple transistors TR11-TR14, TR21-TR24, and TR31-TR34.

In some embodiments, the coupling relationship between internal devices and elements of the power supplying device 200 is similar to the power supplying device 100, and is not repeated herein for simplicity. The differences of the coupling relationship between the power supplying devices 200 and 100 are further discussed as follow.

As illustratively shown in FIG. 2, the input terminal T1 of the converter circuit 210 is coupled to a node A. The input terminal T2 of the converter circuit 210 is coupled to a node B. The input terminal T3 of the converter circuit 210 is coupled to a node C. Each of nodes G1-G3 of the converter circuit 210 is coupled to the midpoint M.

In some embodiments, a terminal of the transistor TR11 is coupled to the node A, and another terminal of the transistor TR11 is coupled to a node N4. A terminal of the transistor TR12 is coupled to the node A, and another terminal of the transistor TR12 is coupled to a node N5. A terminal of the transistor TR13 is coupled to the node N4, and another terminal of the transistor TR13 is coupled to the node G1. A terminal of the transistor TR14 is coupled to the node N5, and another terminal of the transistor TR14 is coupled to the node G1. An anode terminal of the diode D1 is coupled to the node N4, and a cathode terminal of the diode D1 is coupled to the output terminal T4 of the converter circuit 210. A cathode terminal of the diode D2 is coupled to the node N5, and an anode terminal of the diode D2 is coupled to the output terminal T5 of the converter circuit 210.

In some embodiments, a terminal of the transistor TR21 is coupled to a node B, and another terminal of the transistor TR21 is coupled to a node N6. A terminal of the transistor TR22 is coupled to the node B, and another terminal of the transistor TR22 is coupled to a node N6. A terminal of the transistor TR23 is coupled to the node N6, and another terminal of the transistor TR23 is coupled to the node G2. A terminal of the transistor TR24 is coupled to the node N7, and another terminal of the transistor TR24 is coupled to the node G2. An anode terminal of the diode D3 is coupled to the node N6, and a cathode terminal of the diode D3 is coupled to the output terminal T4 of the converter circuit 210. A cathode terminal of the diode D4 is coupled to the node N7, and an anode terminal of the diode D4 is coupled to the output terminal T5 of the converter circuit 210.

In some embodiments, a terminal of the transistor TR31 is coupled to a node C, and another terminal of the transistor TR31 is coupled to a node N8. A terminal of the transistor TR32 is coupled to the node C, and another terminal of the transistor TR32 is coupled to a node N9. A terminal of the transistor TR33 is coupled to the node N8, and another terminal of the transistor TR33 is coupled to the node G3. A terminal of the transistor TR34 is coupled to the node N9, and another terminal of the transistor TR34 is coupled to the node G3. An anode terminal of the diode D5 is coupled to the node N8, and a cathode terminal of the diode D5 is coupled to the output terminal T4 of the converter circuit 210. A cathode terminal of the diode D6 is coupled to the node N9, and an anode terminal of the diode D6 is coupled to the output terminal T5 of the converter circuit 210.

In some embodiments, the converter circuits 110 and 210 have the configuration of the PFC converter circuit. However, the converter circuits 110 and 210 disclosed herein are not limited to this configuration.

Although the present disclosure has been described in considerable detail with reference to certain embodiments thereof, other embodiments are possible. Therefore, the spirit and scope of the appended claims should not be limited to the description of the embodiments contained in the present disclosure.

It will be apparent to those skilled in the art that various modifications and variations can be made to the structure of the present disclosure without departing from the scope or spirit of the disclosure. In view of the foregoing, it is intended that the present disclosure cover modifications and variations of the present disclosure provided they fall within the scope of the following claims.

What is claimed is:

1. A power supplying device, configured to provide power to a load according to a plurality of input power sources, comprising:
a converter circuit, comprising:
a plurality of input terminals configured to be coupled to one of the plurality of input power sources, respectively;
a first output terminal and a second output terminal, configured to be coupled to the load, and configured to generate an output voltage to supply power to the load according to the plurality of input power sources;
a first capacitor coupled to the first output terminal and a first midpoint;
a second capacitor coupled to the second output terminal and the first midpoint;
a first filtering capacitor, a second filtering capacitor, and a third filtering capacitor, respectively coupled to one of the plurality of input power sources and coupled to a second midpoint;
a switch coupled to the first midpoint and the second midpoint; and
a controller configured to control the switch according to an input voltage of the plurality of input terminals;
wherein when the input voltage of the plurality of input terminals is lower than a predetermined voltage level, the switch is configured to be conducted, and
when the input voltage of the plurality of input terminals is higher than the predetermined voltage level, the switch is configured to be not conducted.

2. The power supplying device of claim 1, wherein the predetermined voltage level is 2/\sqrt{3} times a rating voltage.

3. The power supplying device of claim 1, wherein
when the switch is conducted, the first midpoint has a first output voltage level,
when the switch is not conducted, the first midpoint has a second output voltage level, and
the second output voltage level is higher than the first output voltage level.

4. The power supplying device of claim 1, wherein each of the first filtering capacitor, the second filtering capacitor, and the third filtering capacitor is configured to reduce an electromagnetic interference.

5. The power supplying device of claim 1, wherein the converter circuit is implemented by a power factor correction converter circuit.

6. A power supplying device, comprising:
a plurality of input power sources coupled to a first midpoint;
a plurality of input terminal coupled to the plurality of input power sources;
a converter circuit coupled to the plurality of input power sources;
a switch coupled to each of the first midpoint and a second midpoint; and
a controller configured to control the switch according to an input voltage,
wherein the first midpoint is coupled to each of a first output terminal and a second output terminal,
when the input voltage of the plurality of input terminals is higher than a predetermined voltage level, the controller sets the switch to be conducted, and
when the input voltage of the plurality of input terminals is lower than a predetermined voltage level, the controller sets the switch to be not conducted.

7. The power supplying device of claim 6, further comprising:
a first capacitor coupled to the first midpoint; and
a second capacitor coupled to the first midpoint,
wherein the predetermined voltage level is 2/\sqrt{3} times a rating voltage.

8. The power supplying device of claim 7, wherein
the switch is coupled between the first midpoint and the second midpoint, and
the first midpoint is coupled between the first capacitor and the second capacitor.

9. The power supplying device of claim 7, wherein
when the switch is not conducted, the first midpoint has a first output voltage level,
when the switch is conducted, the first midpoint has a second output voltage level, and
the second output voltage level is higher than the first output voltage level.

10. The power supplying device of claim 6, further comprising:
a first filtering capacitor, a second filtering capacitor, and a third filtering capacitor,
wherein each of the first filtering capacitor, the second filtering capacitor, and the third filtering capacitor is coupled to the plurality of input power sources respectively and coupled to a second midpoint.

11. The power supplying device of claim 10, wherein
each of the first filtering capacitor, the second filtering capacitor, and the third filtering capacitor is configured to reduce an electromagnetic interference, and
the converter circuit is implemented by a power factor correction converter circuit.

12. A method for controlling a power supply device coupled to a plurality of input power sources for providing power to a load wherein the power supplying device comprises:
a converter circuit, comprising:
a plurality of input terminals coupled to one of the plurality of input power sources, respectively;
a first output terminal and a second output terminal coupled to the load for generating an output voltage to supply power to the load according to the plurality of input power sources;
a first capacitor coupled to the first output terminal and a first midpoint;
a second capacitor coupled to the second output terminal and the first midpoint;
a first filtering capacitor, a second filtering capacitor, and a third filtering capacitor, respectively coupled to one of the plurality of input power sources and coupled to a second midpoint; and
a switch coupled to the first midpoint and the second midpoint; and
the method comprising:
receiving an input voltage from the input power sources by the input terminals of the converter circuit; and
performing a power converting operation of the input voltage by the converter circuit to generate the output voltage;
when the input voltage of the plurality of input terminals is lower than a predetermined voltage level, configuring the switch to be conducted, and
when the input voltage of the plurality of input terminals is higher than the predetermined voltage level, configuring the switch to be not conducted.

13. The method of claim 12, wherein
when the switch is not conducted, the first midpoint has a first output voltage level,
when the switch is conducted, the first midpoint has a second output voltage level, and
the second output voltage level is higher than the first output voltage level.

14. The method of claim 12, wherein the predetermined voltage level is 2/\sqrt{3} times a rating voltage.

15. The method of claim 12, wherein
the switch is coupled between the first midpoint and the second midpoint, and
the first midpoint is coupled between the first capacitor and the second capacitor.
